(19) United States
(12) Patent Application Publication
(10) Pub. No.: US 2023/0369929 A1
(43) Pub. Date: Nov. 16, 2023

(54) SELF-EXCITED BRUSHLESS MACHINE WITH COMPENSATED FIELD WINDINGS

(71) Applicant: The Texas A&M University System, College Station, TX (US)

(72) Inventors: Hamid A. Toliyat, College Station, TX (US); Seyed Mehdi Seyedi, College Station, TX (US); Dorsa Talebi, College Station, TX (US)

(21) Appl. No.: 18/196,981

(22) Filed: May 12, 2023

Related U.S. Application Data
(60) Provisional application No. 63/341,549, filed on May 13, 2022.

(51) Int. Cl. H02K 3/20; H02K 1/24; H02K 11/042

(52) U.S. Cl. CPC H02K 3/20; H02K 1/24; H02K 11/042

(57) ABSTRACT

A self-excited brushless machine with compensated field windings includes a rotor and a stator. The rotor Includes a field winding secured to the rotor, an auxiliary winding secured to the rotor, and an energy converter associated with the rotor and configured to convert current between the field winding and the auxiliary winding. The stator includes a multiphase winding. The self-excited brushless machine uses a first current to generate a first magnetomotive force on a stator of the machine, and uses a second current to generate a second magnetomotive force. A third current is induced on auxiliary windings of a rotor of the machine using the second magnetomotive force. A rotor field winding of the machine is excited with the induced currents of the auxiliary windings.

### CROSS REFERENCE TO RELATED APPLICATIONS

This patent application claims priority from, and incorporates by reference the entire disclosure of, U.S. Provisional Patent Application No. 63/341,549 filed on May 13, 2022.

### TECHNICAL FIELD

The present disclosure relates generally to magnetic systems, but not by way of limitation, to Self-Excited Brushless Machines (SEBM) with compensated field windings.

### BACKGROUND

This section provides background information to facilitate a better understanding of the various aspects of the disclosure. It should be understood that the statements in this section of this document are to be read in this light, and not as admissions of prior art.

Electric machines often utilize brushes and slip rings to permit current to flow from a stationary part to a rotating part. Brushes and slip rings rely on physical contact between two parts for current to pass therethrough. While brushes and slip rings can be effective, the physical contact between the parts creates wear that requires maintenance or that can lead to failures. An electric machine design that does not rely on brushes and slip rings to allow current to flow between a stationary part and a moving part would eliminate the maintenance associated with brushes and slip rings and allows for improved packaging options for the electric machine as space for the brushes and slip rings is no longer required.

### SUMMARY

A self-excited brushless machine with compensated field windings includes a rotor and a stator. The rotor Includes a field winding secured to the rotor, an auxiliary winding secured to the rotor, and an energy converter associated with the rotor and configured to convert current between the field winding and the auxiliary winding. The stator includes a multiphase winding. The self-excited brushless machine uses a first current to generate a first magnetomotive force on a stator of the machine, and uses a second current to generate a second magnetomotive force. A third current is induced on auxiliary windings of a rotor of the machine using the second magnetomotive force. A rotor field winding of the machine is excited with the induced currents of the auxiliary windings.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a schematic diagram of a Self-Excited Brushless Machine according aspects of the disclosure;

FIG. 2 is a schematic diagram of a Self-Excited Brushless Machine with compensated field winding according to aspects of the disclosure;

FIG. 3 is a schematic diagram of a stator configuration with a five-phase winding according to aspects of the disclosure;

FIG. 4 is a schematic diagram of an inner rotor configuration of an SEBM according to aspects of the disclosure;

FIG. 5 is a schematic diagram of an outer rotor configuration of an SEBM according to aspects of the disclosure;

FIG. 6 is a schematic diagram of an SEBM with hybrid excitation using permanent magnets according to aspects of the disclosure;

FIG. 7 is a schematic diagram of an SEBM with a linear translator according to aspects of the disclosure; and

FIG. 8 is a schematic diagram of a portion of an axial rotor for an SEBM according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

In various aspects, the invention involves an electric machine with a multiphase stator winding that can operate without brushes and slip rings, leading to fewer maintenance requirements. The machine includes a rotor having two sets of windings, a field winding for synchronous torque and auxiliary windings for exciting the field winding. In various aspects, a multiphase winding is used to produce additional independent spatial harmonics to induce AC current on the auxiliary windings. A converter is employed to convert the induced AC currents on the auxiliary windings to AC or DC current for the field winding(s) so that flux from the rotor interacts with flux from the stator to produce torque. Since the number of poles for harmonic flux differs from fundamental flux, this feature can be used for wireless power transfer from the stator to the rotor through the auxiliary windings. In a Self-Excited Brushless Machine (SEBM), the multiphase winding is excited with two terms consisting of the fundamental and harmonic currents. Fundamental current is used to generate the main magnetomotive force (MMF) on the stator. The additional harmonic current generates another MMF used to induce currents on the auxiliary windings. By implementing a converter on the rotor, induced currents in the auxiliary windings excite the rotor field winding. So, the stator excitation controls fundamental and harmonic MMFs on the stator and indirectly controls the fundamental MMF on the rotor. Since the harmonic MMF is controlled independently by the harmonic current with a different number of poles, the frequency and amplitude of harmonic MMF can be controlled based on rotor speed. The compensation method controls the frequency of harmonic MMF to achieve the maximum torque at different rotor speeds. Especially at lower rotor speeds, induced frequency is compensated to produce the required torque without increasing the magnitude of harmonic current. U.S. Patent Publication No. 2021/0336574 describes various brushless wound field synchronous machines. The entire disclosure of U.S. Patent Publication No. 2021/0336574 is incorporated herein by reference.

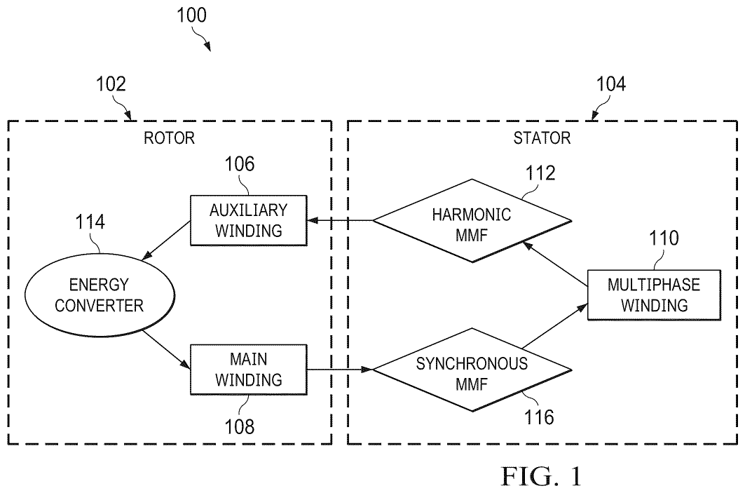

FIG. 1 illustrates a schematic structure of an SEBM 100. SEBM 100 includes a rotor 102 and a stator 104. Rotor 102 includes an auxiliary winding 106 and a main or field winding 108. Stator 104 includes a multiphase winding 110. Multiphase winding 110 creates a rotating harmonic MMF 112, which induces a current in auxiliary winding 106. The induced current in auxiliary winding 106 excites field winding 108 using an energy converter 114. Field winding 108 creates a synchronous MMF 116 that interacts with a fundamental MMF of stator 104, which ultimately produces Electromagnetic (EM) torque that may be used to rotate a shaft etc.

Using a variety of power conversions between auxiliary winding 106 and main winding 108 can create different types of SEBM 100. In a first type, an AC/DC rectifier is used for rotor power conversion and a compensated DC field is created. In a second type, an AC/AC converter is used for rotor power conversion and a compensated AC field is created. In a third type, an AC/DC rectifier with a permanent magnet is used for rotor power conversion and a hybrid DC excitation is created.

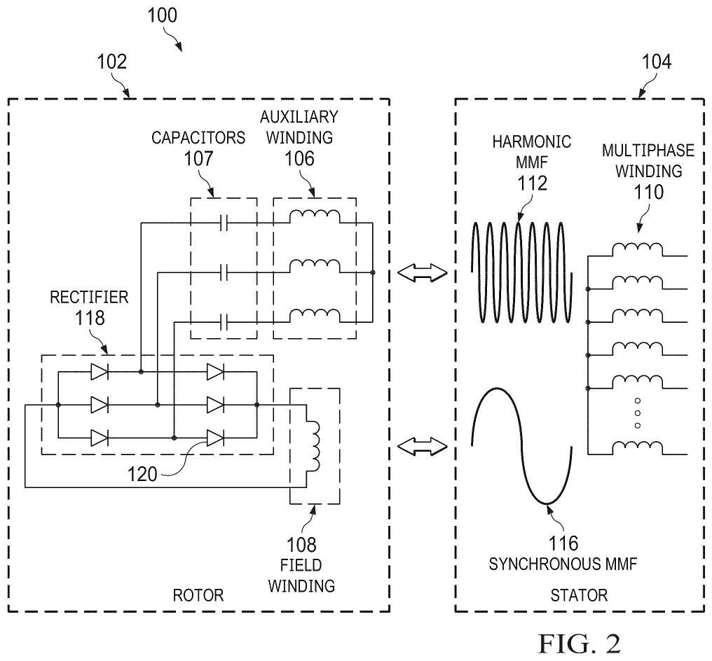

According to the first type, AC current induced in auxiliary winding 106 is converted to DC current, similar to a wound field synchronous machine. Field winding 108 carries DC current, which is used for producing fundamental rotor MMF. The rotor speed is synchronous with the fundamental MMF created by multiphase winding 110. The power converter is an AC/DC rectifier 118 and can be controlled by active switches or passive diodes 120 (e.g., see FIG. 2).

According to the second type, power transfer from auxiliary winding 106 to field winding 108 can be converted to another AC current with a different magnitude and frequency. An active AC/AC converter is used in this case, and switching gate commands are controlled through a wireless transmission interface. The fundamental MMF created by stator 104 has an asynchronous speed concerning both the harmonic MMF and the rotor speed.

According to the third type, compensated DC Field (Type 1) and Permanent Magnets (PM) are combined. This structure is a hybrid DC excited brushless machine that uses both winding of rotor 102 and PMs. The harmonic current excitation controls the field MMF; however, MMF created by PMs is constant.

FIG. 2 illustrates a schematic structure of an SEBM 100 with compensated DC field (Type 1). A unique set of multiphase winding supplied by an inverter controls both the fundamental and the harmonic currents. Harmonic MMF 112 induces a voltage on auxiliary winding 106, and the induced current is rectified through diodes 120 of rectifier 118 to supply current to field winding 108. A plurality of capacitors 107 are arranged between auxiliary winding 106 and rectifier 118. Field winding 108 creates a synchronous MMF 116 that interacts with a fundamental MMF of stator 104. The interaction between field winding 108 and the fundamental MMF produces EM torque. The induced voltage frequency on auxiliary winding 106 is compensated to a consistent value by adjusting the harmonic frequency. With a constant rate of induced frequency, the torque decreases at lower speeds because of reduced induced frequency. So, by increasing the harmonic frequency, the reduction of induced frequency is compensated. Therefore, a capacitive impedance is used, and it can minimize the leakage inductance effect and reduces the required harmonic current.

The number of phases for stator windings can be any number greater than or equal to two. The current equation for one of the phases in an SEBM can be generalized as Equation (1) below. The first term is the excitation for generating the synchronous MMF, while the second term creates the harmonic rotating MMF.

i_{phase_k}=I_{mF} cos(ω_{F}t−φₖ)+I_{mH} cos(ω_{H}t−nφₖ) Eq. (1)

ω_{F} and ω_{H} are the fundamental and harmonic frequencies respectively, I_{mF} and I_{mH} are the peak values of the fundamental and harmonic currents, n is the order of harmonic and φₖ is the shift angle of phase k. The order of harmonic MMF and its magnitude change based on the number of phases. In general, the number of poles for the main field and stator winding is arbitrary. However, the number of poles for the auxiliary windings is determined from the main field poles times the order of harmonic used for excitation. Rₚ is defined as the ratio of pole numbers of the auxiliary winding to the main winding pole numbers. Rₚ can be any odd number more than one; however, because higher-order harmonic MMF requires more harmonic current excitation, it is reasonable to use lower harmonic orders.

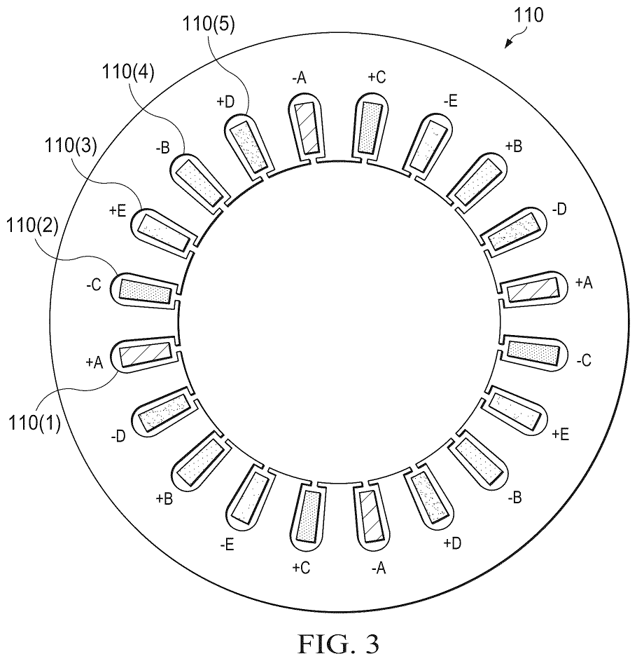

FIG. 3 shows a typical stator design (e.g., stator 104) for an SEBM with a multiphase winding 110 having five-phase stator windings 110(1)-110(5) (phases A-E). The current excitation for the five-phase stator windings can be attained from Equation (1). The winding is considered full pitch to gain maximum harmonic MMF. Short pitch winding could be used as well, but the magnitude of harmonic MMF decreases and yields a higher rate of harmonic current excitation. The stator windings could be double or single layers depending on the design and application.

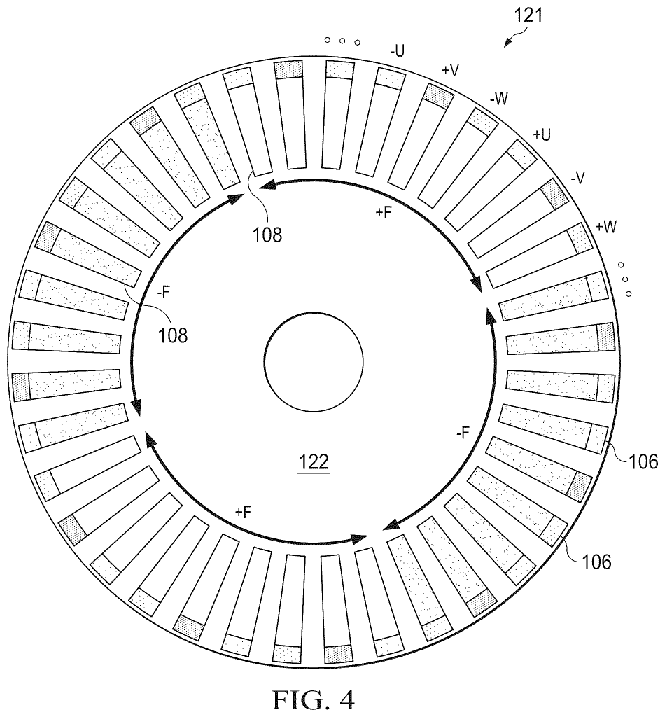

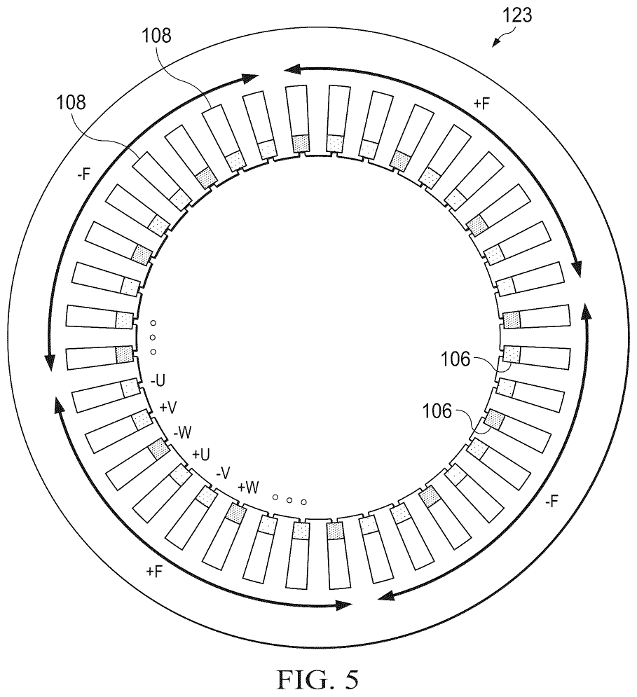

A typical rotor for use with an SEBM has at least two sets of windings. First, a single-phase winding serves as the synchronous machine field winding (e.g., field winding 108). The other is the auxiliary winding (e.g., auxiliary winding 106) utilized for power transfer from stator 104 to rotor 102. The auxiliary winding can be multiphase based on the rotor geometry; however, a single-phase can also be implemented even though the pulsating output current of the rectifier will increase sharply. FIG. 4 illustrates an exemplary inner rotor 121. Inner rotor 121 may be used as rotor 102 in various aspects. Inner rotor 121 is composed of rotor laminated steel 122, field winding 108, and auxiliary winding 106. Inner rotor 121 may include a rectifier and capacitors that are placed on inner rotor 121. In the aspect of FIG. 4, field winding 108 is a four-pole winding which is considered the synchronous excitation. In this configuration, auxiliary winding 106 is twelve poles (three times the main winding poles) and represents the wireless power transfer through the air gap and excites field winding 108. Auxiliary winding 106 has three phases to create a smooth DC current at the output of the multiphase rectifier and to help reduce torque ripple. FIG. 5 illustrates an exemplary outer rotor 123. Outer rotor 123 may be used as rotor 102 in various aspects. In the outer rotor configuration, auxiliary winding 106 has n times the number of poles of field winding 108, where n is the harmonic order used for excitation. In FIG. 5, the rotor field and auxiliary windings have four and twelve poles, respectively.

The structure of the SEBM with compensated AC field (Type 2) is similar to DC field winding (Type 1). In the case of AC excitation, the field winding should be more than one phase to create a rotating MMF. All mentioned equations, stator, and rotor structure are also valid for the compensated AC field SEBM. However, in this case, the rotor rotates in an asynchronous manner with the stator fundamental MMF speed. To control the AC/AC converter, a wireless transmission circuit may be used to command the converter switches.

SEBM can have a hybrid DC excitation combined with compensated DC field and PMs (Type 3). In Electric Vehicle (EV) applications, which usually operate in the constant power region, a high stator current is needed for field weakening in permanent magnet motors. This may cause irreversible demagnetization and decrease efficiency in high-speed operation. Further design and optimization of the motor can reduce and/or prevent the demagnetization. A combination of SEBM with PMs will provide the opportunity to reduce the harmonic excitation current at higher speeds achieving lower torques without the need for high stator currents for weakening the PM flux. This will result in a remarkably lower demagnetization risk because there is no opposite field against the PMs. The use of PMs results in a higher torque density in SEBM. Also, the control scheme of field weakening is much easier in SEBM; instead of implementing stator current to reduce the airgap field, the harmonic current is reduced. To combine the structure of the SEBM rotor with additive PMs, it is necessary to decouple the magnetic path of PMs and copper windings.

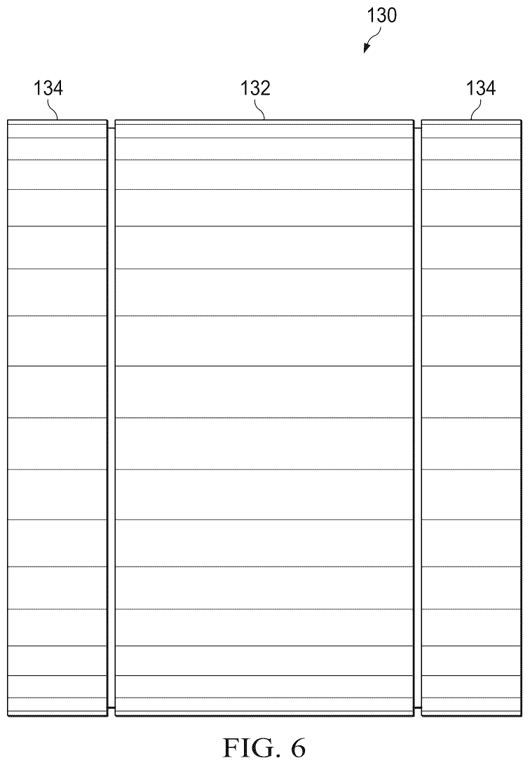

FIG. 6 illustrates an exemplary SEBM 130 with PMs 132 placed on either side of a rotor 134, with windings placed over the whole cross-section. The field winding generates MMF over the whole airgap peripheral, while PMs create MMF in the adjunct section(s). In peripheral sides, because of the existence of PMs, there is a high reluctance path that reduces flux created by the winding in those sections. So, the main MMF produced by the field winding crosses the main section (i.e., rotor 134). The volume portion of field winding and PM section depends on the power requirement of the motor (MMF produced by the field winding and PMs based on torque-speed characteristics). Also, the PMs can be placed over the whole cross-section of rotor 134 if they do not block the magnetic flux path of the copper windings.

### Working Examples

An SEBM with compensated DC field and radial machine topology was evaluated, and transient responses were measured. The transient-response of field current with the rotor rotating at synchronous speed, and harmonic excitation is implemented in addition to the fundamental current. Since a voltage is induced in the auxiliary winding, building the current takes some time. Testing resulted in a field current of approximately 4 A after about 0.1 s. The three-phase auxiliary windings and the rectified field currents at the steady-state were measured. The induced voltage generated by the auxiliary winding creates a DC current of approximately 4 A using the rotor side rectifier and excites the field winding to make the rotor field MMF. Consequently, developing the rotor MMF increases the EM torque and reaches the steady-state condition. The transient response of EM torque was measured, with the steady-state torque output being approximately 30 Nm once the current had stabilized.

The harmonic MMF created by the harmonic current excitation has a different pole number than synchronous MMF. The difference between the harmonic MMF speed and the synchronous MMF speed determines the frequency of induced voltage in the auxiliary winding. On the other hand, the induced voltage frequency can be modified by changing the harmonic excitation frequency. Thus, with proposed harmonic excitation, the frequency of induced voltage can be adjusted to the synchronous speed. At low speed, the induced voltage drops because of lower induced frequency. The compensation method will determine the induced voltage frequency by adjusting the harmonic excitation frequency at different speeds. This method will help keep the torque constant without increasing the harmonic current excitation. Since the induced voltage frequency in the auxiliary winding is consistent with the compensation method, a capacitor is used to reduce the leakage effect of the winding and increase the induced voltage, as mentioned previously.

The Compensated Induced Frequency (CIF) is the induced voltage frequency in the auxiliary winding. The average torque and efficiency at different speeds for various CIFs were measured. EM torque is adjusted at a constant rate, and the efficiency is high enough during the low-speed region. Testing showed that a higher CIF value increased the torque, but resulted in a reduction in efficiency primarily as a result of the core loss effect.

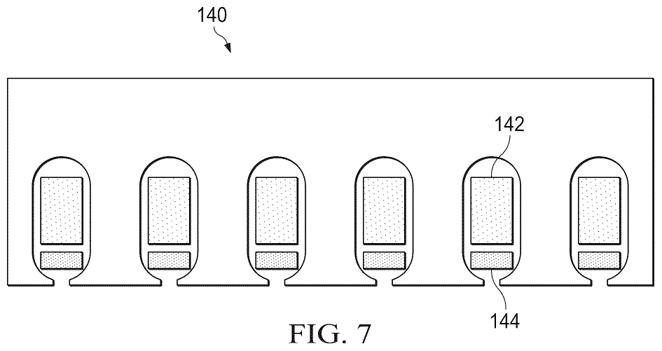

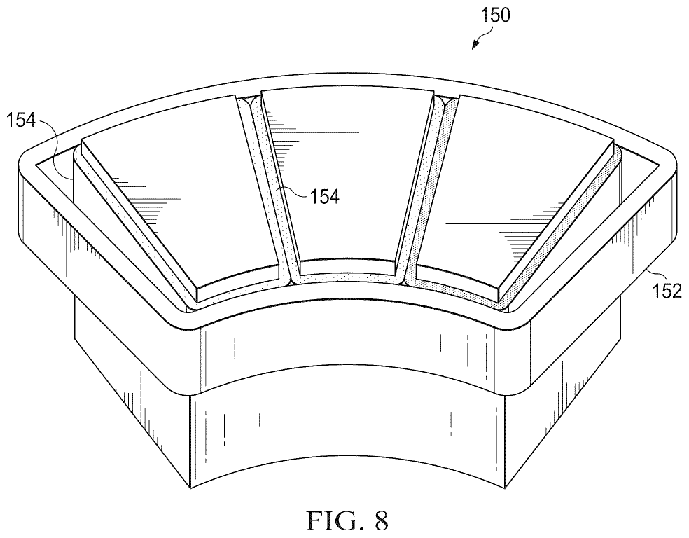

All embodiments that are Type 1, Type 2, and Type 3, having an inner rotor and outer rotor are also practical for linear and axial flux machines. FIG. 7 illustrates a linear rotor structure 140 for an SEBM. The linear rotor structure includes a plurality of field windings 142 and auxiliary windings 144 for synchronous torque production and wireless power transfer. A portion of a flux rotor structure for an SEBM is shown in FIG. 8. FIG. 8 illustrates a quarter of a flux axial rotor structure 150. Flux axial rotor structure 150 includes a field winding 152 that surrounds a plurality of auxiliary windings 154. This structure can be repeated to form an entire rotor (e.g., four times for the configuration shown). The rotor for linear and axial machines consists of a field and an auxiliary winding for synchronous operation and induction excitation.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A self-excited brushless machine with compensated field windings, the machine comprising:
a rotor comprising:
a field winding secured to the rotor;
an auxiliary winding secured to the rotor; and
an energy converter associated with the rotor and configured to convert current between the field winding and the auxiliary winding; and
a stator comprising a multiphase winding.

2. The self-excited brushless machine of claim 1, wherein the energy converter is configured to convert AC current induced in an auxiliary winding to DC current.

3. The self-excited brushless machine of claim 1, wherein the energy converter is configured to convert a first AC current induced in an auxiliary winding to a second AC current having a different magnitude and frequency.

4. The self-excited brushless machine of claim 3, wherein the energy converter comprises an active AC/AC converter.

5. The self-excited brushless machine of claim 4, wherein the energy converter comprises a wireless transmission interface that controls switching gate commands.

6. The self-excited brushless machine of claim 1, wherein the energy converter comprises an AC/DC rectifier with a permanent magnet.

7. The self-excited brushless machine of claim 1, wherein the rotor comprises:
a rectifier;
an auxiliary winding electrically coupled to the rectifier; and
a field winding electrically coupled to the rectifier.

8. The self-excited brushless machine of claim 1, wherein:
the field winding is a single-phase winding that serves as a synchronous machine field winding; and
the auxiliary winding is configured for power transfer from the stator to the rotor.

9. The self-excited brushless machine of claim 8, wherein the auxiliary winding is a multiphase winding.

10. The self-excited brushless machine of claim 8, wherein the auxiliary winding is a single-phase winding.

11. The self-excited brushless machine of claim 1, wherein the rotor and the stator have radial geometry.

12. The self-excited brushless machine of claim 1, wherein the rotor and the stator have linear geometry.

13. The self-excited brushless machine of claim 1, wherein the rotor and the stator have axial geometry.

14. The self-excited brushless machine of claim 6, wherein the permanent magnets are placed all over the rotor cross-section.

15. The self-excited brushless machine of claim 6, wherein the permanent magnets are placed on the adjunct section(s) of the rotor.

16. A method of operating a machine, the method comprising:
using a first current to generate a first magnetomotive force on a stator of the machine;
using a second current to generate a second magnetomotive force;
inducing a third current on auxiliary windings of a rotor of the machine using the second magnetomotive force; and
exciting a rotor field winding of the machine with the induced currents of the auxiliary windings.

17. The method of claim 16, wherein the rotor comprises an energy converter.

18. The method of claim 17, wherein the energy converter converts AC current induced in the auxiliary winding to DC current.

19. The method of claim 16, wherein the energy converter converts a first AC current the auxiliary winding to a second AC current having a different magnitude and frequency.

20. The method of claim 16, wherein the energy converter comprises an active AC/AC converter.
